(19) United States
(12) Patent Application Publication
(10) Pub. No.: US 2004/0014417 A1
(43) Pub. Date: Jan. 22, 2004

(54) System and method for controlling air extraction speed, in particular in laboratory hoods

(76) Inventor: Alain Katz, Dammarie les lys (FR)

Correspondence Address: YOUNG & THOMPSON, 745 SOUTH 23RD STREET 2ND FLOOR, ARLINGTON, VA, 22202

(21) Appl. No.: 10/312,988

(22) PCT Filed: Jun. 28, 2001
(86) PCT No.: PCT/FR01/02049

(30) Foreign Application Priority Data
Jul. 3, 2000 (FR) 00/08640

(51) Int. Cl. B08B 15/02

(52) U.S. Cl. 454/62

(57) ABSTRACT

The invention concerns a system for controlling the frontal speed of a set of ventilating air extracting equipment (1, 2, 3, 4), in particular from laboratory hoods, inside premises. Each hood is connected to ventilating air extracting means (5, 6) and comprises means for regulating (10, 11, 12, 13) the frontal air speed, means for controlling the extracted air flow rate (18, 19, 20, 21, 22, 23, 24, 25, 26), means for measuring the executed air flow, and means for measuring the frontal air speed (14, 15, 16, 17). Said system further comprises: a local communication network (38) whereto the respective regulating means (10, 11, 12, 13) of said hoods are connected as slave regulators; a master regulator (8) connected to said local communication network and adapted to provide a gateway between said slave regulating means (10, 11, 12, 13) and remote control means (35, 36, 37), and to collect and add the extracted air measurements on each ventilating air extracting equipment.

The present invention concerns a system for controlling face velocity for extraction aeraulic equipments such as hoods for laboratories, also called Sorbonne hoods, used for protecting technicians and operators against emissions due to toxic or corrosive handlings. It also concerns a control method implemented in this system.

Extraction aeraulic equipment means here the whole of extraction hoods equipping all types of rooms, in particular laboratories, clean rooms or meeting rooms, but also hoods equipping industry kitchens, and air extractors equipping single rooms in hotels, retirement houses, clinics, hospitals or boat cabins.

The protection provided by a laboratory hood is obtained by aspirating polluted air derived from the handling. These laboratory hoods are used for confining pollutants, for discharging these pollutants without creating dead and polluted internal zones with concentrations such as that explosive atmospheres would be constituted, and for protecting the operator against splashes from casual reactions.

Generally, a hood is made up of a bench protected laterally by two jambs, and frontally by a transparent sash, usually in glass. The frontal sash can slide for providing a variable working opening. Air is extracted by a duct connected to an external discharge chimney. A fan, of the centrifugal type, is located outside the building.

For safety reasons and in order to comply with current standards, hoods are equipped with an alarm controlled by a device for continuously monitoring the extracted air flow or for measuring the face velocity. As a way of example, the NF X 15203 standard specifies an average face velocity that is above or equal to 0.5 meter per second.

Furthermore, a significant energy consumption is observed in a conventional laboratory since hoods emit in the external environment air that is aspirated in the laboratory, said air being possibly warmed in winter and cooled in summer. In order to limit energy expenses while keeping an optimal safety level, a system is installed for accurately controlling the face velocity in the hoods.

There are systems for controlling-driving a set of hoods in a laboratory. One can cite Document U.S. Pat. No. 5,240,445 (Phoenix Controls Corp) that discloses a method permitting to maintain a low face velocity when no activity is detected in the hood and to accelerate the discharge when a user is present. The document U.S. Pat. No. 4,706,553, by the same applicant, is also known and relates to a system for controlling the face velocity according to the opening of the window in order to optimize the energy expenses. The document U.S. Pat. No. 5,831,848, still with the same applicant, can also be cited, wherein there is disclosed a system comprising a master controller connected, on one hand to a plurality of controllers that are slaves of a laboratory through a communication network, and on another hand to a plurality of master controllers through another communication network.

The document EP0884116 (Landis & Staefa, Inc.) is also known, wherein a control unit is taught as comprising an apparatus for detecting the presence of objects within a chimney hood in order to reduce the flow through this hood when no object is detected, thus permitting to reduce the energy consumption.

But these prior systems are costly and complex, and for the most part of them, a lack of communication with possible centralized technical management systems.

The present invention is aimed to overcome these drawbacks by proposing a modular control-drive system using few components.

The invention is also aimed to a system able to communicate with other external systems.

The object of the invention is also the implementation of a technique limiting the energy consumptions while guaranteeing a maximum safety level.

Afterwards, laboratory means a room containing one or several hoods.

The above-cited objectives are reached with a system for controlling the face velocity of one or a plurality of extraction aeraulic equipments, in particular laboratory fume hoods, within a place, these extraction equipments being linked to aeraulic extraction means and each comprising means for regulating the face velocity of said equipments, means for controlling the extracted airflow, means for measuring the extracted airflow, and means for measuring the face velocity. Each equipment can be a laboratory hood.

According to the invention, this system further comprises:

a local communication network to which the respective regulation means of said aeraulic equipments are connected as slave-regulators;

a master regulator connected to said local communication network and arranged (i) for making a gateway between said slave regulators and remote means for controlling the aeraulic extraction means, and (ii) for collecting and summing the measurements of extracted airflows on each aeraulic extraction equipment.

According to a preferred way of implementation of the invention, the master regulator and the slave regulators comprise an identical architecture and are arranged so as to establish multi-protocols communications. The difference between master and slave is obtained by a software or hardware configuration.

The master regulator can control a flow of air blown in the place by means of a valve, controlled for example by a pneumatic motor, and of a differential pressure probe, located on a blow duct. The valve control permits to regulate the face velocity at a given value.

The master regulator can also manage the temperature and the blown air in the place in function of the information transmitted by the plurality of slave regulators, in particular information coming from the means for measuring the flow of air extracted in each hood. In this case, the slave regulators are used as relays for these information. The management of temperature may require the use of a warming set.

The control of a blow duct allows to get at any time a predetermined differential between the extracted airflow and the blown-air flow and to ensure a regulation of the ambient temperature.

According to an advantageous feature of the invention, the master regulator includes at least a location wherein a communication daughter card is inserted, said daughter card comprising a microprocessor and an interface that are dedicated to a communication protocol of a given communication network.

According to the invention, the daughter-card can be connected to another master regulator managing a plurality of slave regulators located in another place.

The daughter card can also be connected to an industrial network linking a plurality of master regulators, said industrial network being managed by a supervisor. This supervisor manages the industrial network by means of a computer provided with a software for supervising and configuring the whole regulators.

Advantageously, the master regulator transmits face velocity setpoints, generated by a supervisor, to the slave regulators, said setpoints being function of a cycle of predetermined duration.

This feature can be used for a night and day working of a laboratory. In order to save energy, each slave regulator can for example be programmed so as to enslave the face velocity to a value of 0.25 meter per second during night. In order to optimize the energy saving, a minimal opening of, for example, ten per cent for the sash of a hood can also be imposed mechanically in case of non-presence of an operator, which can be automated by using a presence sensor located on each hood. The presence sensor activates via the slave regulator the mechanical descent of the sash.

The communication between the master regulator, the slave regulators, the different sensors and the converters, can be made by transmitting digital, analogue or of all-or-nothing type data.

The system according to the invention permits to implement a face velocity control method for a set of extraction aeraulic equipments, in particular laboratory hoods. This method comprises:

a slave-type regulation for controlling the face velocity of the air aspirated by each of said extraction aeraulic equipments;

a master-type regulation for controlling the air blown in the laboratory.

According to the invention, the method further comprises a management of a set communication protocols with a plurality of industrial networks to provide with a remote control of the master regulation and of the slave regulation.

According to another aspect of the invention, a device for controlling the face velocity of an extraction aeraulic equipment, in particular a laboratory hood, within a place, is proposed, said equipment comprising means for regulating the face velocity, means for controlling the extracted airflow, and means for measuring the face velocity.

According to the invention, the regulation means comprise a regulator including at least a location wherein a plurality of communication daughter cards can be inserted, each of the daughter cards including a microprocessor and an interface dedicated to a communication protocol of a given communication network.

Preferably, this regulator works in an autonomous manner, i.e. non connected to other regulators.

With such a daughter card, the system is called open since it can communicate with all types of industrial networks using different communication protocols. The daughter card can be connected to a communication network that is external to the laboratory, a communication network such as an industrial network (also called fieldbus) using one of the following protocols; LONWORKS, CAN, Jbus, Modbus, TCP/IP, RS485, . . . , these protocols being cited as way of examples and in a non-limitative manner.

When a differential pressure probe for measuring the extracted airflow is used with this autonomous regulator, the information concerning this air-flow are used for controlling an air-extraction centrifugal motor so as to maintain the face velocity at a given setpoint value.

The means for measuring the face velocity can comprise a face velocity transmitting digital data.

The means for controlling the extracted airflow can comprise an extraction valve controlled by a pneumatic motor, a stepping motor, a linear motor or any other motor.

Furthermore, the regulator can comprise means for connexion to a plurality of other regulators.

According to the invention, the daughter card is connected to a remote centralized-technical management equipment.

The regulator can for example include two locations for two different daughter cards, each daughter card being intended for a given communication protocol, this protocol depending on the type of network to which each daughter card can be connected. This connexion can be made by means of an optical interface, a twisted-pairs interface, a coaxial-cables interface, or still a radiofrequency interface.

Other features and advantages of the invention will become apparent in the following description. To the attached drawings given as way of non-limitative examples:

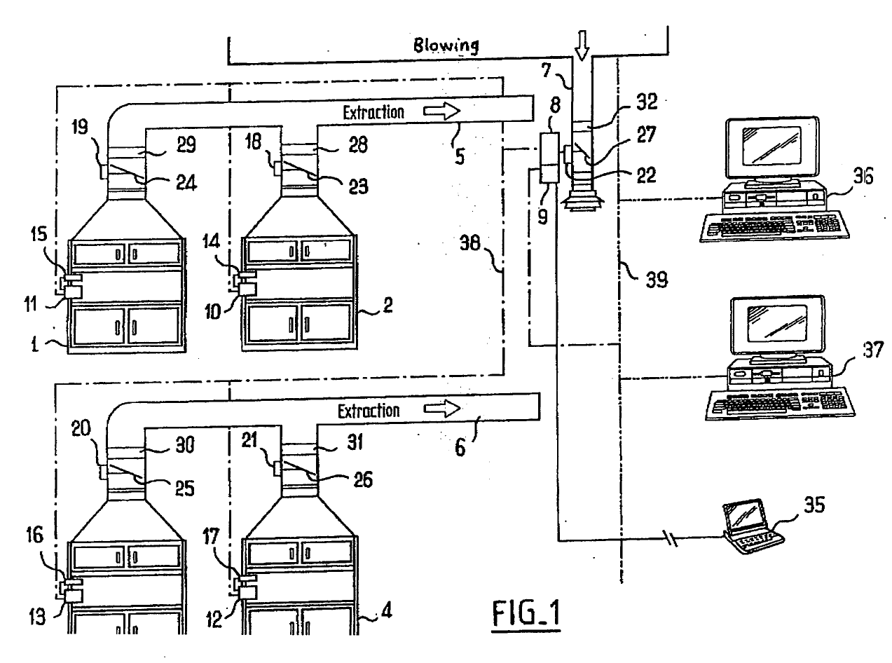

FIG. 1 is a synoptic scheme of a regulation system according to the invention; and

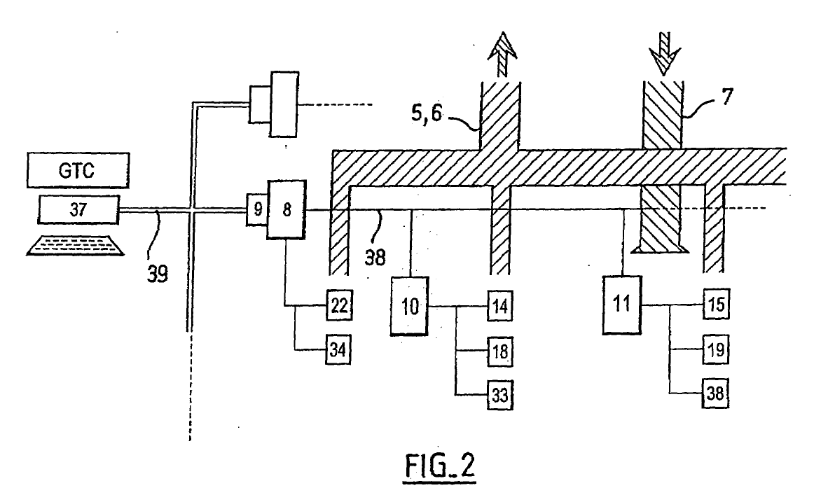

FIG. 2 is a synoptic scheme representing different networks used in the system of FIG. 1

Afterwards, the slave regulator will be called a face velocity regulator.

On FIG. 1, four hoods 1-4 arranged in a laboratory are seen. The air is extracted from the laboratory by passing in the hoods then in extraction ducts 5 and 6. These ducts are linked to a centrifugal motor, non represented, that is located outside the laboratory. One skilled in the art will easily understand that the ducts can further comprise air-extraction mouths that are non connected to hoods. To be able to replace the air in the laboratory, air blown through a blowing duct 7 is introduced.

To regulate the face velocity measured by a fast-reaction probe 14, 15, 16, 17 located on each hood close to an opening of said hood, the system comprises a master regulator 8 controlling the air blown through the duct 7 in function of the air extracted by the ducts 5 and 6.

The master regulator 8 receives from the face velocity controllers information, under a digital form, that are relative to the flow of air extracted by each hood. This air flow is measured by a differential pressure probe 28, 29, 30, 31 located in the extraction duct over the hood. The master regulator and the face velocity controllers communicate through a twisted-pairs network 38, this network can be a coaxial cable, optical fibre, radiofrequency network . . .

Each face velocity controller manages the flow of air extracted in the corresponding hood so as to maintain a velocity of 0.5 meter per second for example. For this purpose, each face velocity controller controls a valve 23, 24, 25, 26 according to the data gathered on a velocity probe 14, 15, 16, 17. The velocity probe transmits data under digital form. The valve 23, 24, 25, 26 is place between the differential pressure probe 28, 29, 30, 31 and the hood 1, 2, 3, 4.

In other terms, each face velocity controller, or salve regulator, permits to:

receive a signal from the velocity probe,

analyze this signal so as to maintain a constant face velocity by controlling the valve by one or several controls of PID (Proportional Integral Derivative) control type, the valve then modifying the extracted airflow,

receive a signal, relative to the value of the extracted airflow, coming from the differential pressure probe,

display the value of the face velocity,

be able to modify the value or the face velocity in function of the setpoint transmitted by the master regulator,

launching an alarm if the value of the face velocity does no more correspond to limit values, and

go to a maximum extraction flow in case of emergency, for example when a user pushes an emergency button.

These features permit a totally autonomous working for the face velocity controller in the case of laboratory with a single hood.

The valve 23, 24, 25, 26 is actuated by a pneumatic or electromechanical motor 18, 19, 20, 21 receiving a signal for electrically controlling the face velocity controller (as way of example, a voltage varying between 0 and 10 volts, or still a current varying between 4 and 20 mA). This conversion permits to get an extremely short reaction time for the motor an then to regulate the face velocity in an efficient way is inserted.

The communication between the regulators is done in a digital way.

The master regulator also controls a blow valve 27 located in the blow duct 7 for example by means of an electro-pneumatic converter 22. The measurement of the blown-air flow is made by a differential pressure probe 32.

The master regulator 9 is under the form of a mother card on which a daughter card 9 linked to a remote management 35 service is inserted. Moreover, the daughter card 9 is connected, by means of a twisted pair, to a network 37 external to the laboratory and using for example the RS485 protocol. The invention is remarkable by the fact that this external network can be of any type of networks.

Each face velocity controller, or slave regulator, can also receive a daughter card permitting it to communicate directly with a remote network or by passing through the master regulator.

If the external network is based on optical fiber, a second daughter card the microprocessor and the connectors of which permit a connection to an optical fiber, are inserted in a second location of the mother board or in place of the daughter card 9. Furthermore, one can devise an electronic card provided with a set of connectors (twisted pair, coaxial cable, optical fiber, . . . for different types of networks or still several interchangeable electronic cards each comprising a connector for a given type of network. As way of example, the following external networks can non limitatively cited: Lon, Profibus, Jbus/modbus, Can, . . .

The whole master and slave regulators comprise an identical architecture. The difference between master and slave is obtained by software configuration: the master regulator comprises a master-architecture internal software while the face velocity controllers each comprise a slave-architecture internal software.

The configuration can also be made by hardware using switches. These software are downloaded in storage means within the regulators.

The main elements and features of a regulator (master or slave) are the followings:

analogue inputs and outputs;

logic inputs and outputs;

digital inputs and outputs;

internal regulation software;

internal master/slave architecture software;

PID control adjustment modules;

temperature control;

control of the flows of extracted and blown air;

location for daughter card;

link for remote configuration, remote maintenance, and remote management;

data logger;

display of the face velocity;

display of the face velocity setpoint;

low velocity alarm;

alarm of flow difference between blowing and extraction; and

high velocity alarm.

With such a system, the control of a laboratory set is facilitated by using a supervision computer 36 connected to the external network 39. This computer 36 includes a configuration and supervision software permitting to manage the regulators 8, 10, 11, 12, 13 of this system. This software is of the multi-platforms type and comprises the functions required for multi-protocols communication.

A centralized technical management can also be achieved by connecting a computer server 37 on the external network 39. The present invention therefore permits to obtain a communicating system that can be integrated in all types of industrial networks.

On FIG. 2, the architecture of communication linking the regulators and peripheral elements is schematically represented. Each laboratory comprises a master regulator in linkage with a plurality of face velocity controllers. As the regulation of the face velocity of the hoods is made by the face velocity controllers of slave regulators, the master regulator plays a function of gateway between a local network of face velocity controllers and an external network represented by the supervisor 36 and other master regulators of other laboratories.

FIG. 2 illustrates three types of network which co-exist:

the aeraulic network represented by blowing ducts 7 and extraction ducts 5, 6;

the local network 38 connecting the face velocity controllers to the master regulator; and

the external network 39 connected to a centralized technical management equipment.

It is moreover important to note that the control system according to the invention can be advantageously implemented to provide the support of system for protecting isolated workers (PIW), when several rooms comprising or not hoods but each equipped with a control system according to the invention are all connected via one or several communication industrial networks to a remote central site provided in particular for collecting alarm information transmitted by alarm units arranged in each room and linked to the master regulator equipping said room.

Of course, the invention is not limited to examples that have been described and numerous adjustments can be provided to these examples without departing from the scope of the invention.

1. A system for controlling the face velocity of one or of a plurality of aeraulic equipments for extraction (1, 2, 3, 4), in particular fume hoods for laboratories, within a place, said extraction equipments being linked to aeraulic extraction means (5, 6) and each comprising means (10, 11, 12, 13) for regulating the face velocity of said equipment, means (18, 19, 20, 21, 23, 24, 25, 26) for controlling the extracted airflow, means (28, 29, 30, 31) for measuring the extracted airflow, and means for measuring the face velocity (14, 15, 16, 17), characterized in that this system further comprises:
a local communication network (38) to which the respective regulation means (10, 11, 12, 13) of said aeraulic equipments are connected as slave regulators;
a master regulator (8) connected to said local communication network and arranged (i) for achieving a gateway between said slave regulators (10, 11, 12, 13) and remote means (35, 36, 37) for controlling the aeraulic extraction means, and (ii) for collecting and summing measurements of extracted airflow on each aeraulic extraction equipment.

2. System according to claim 1, characterized in that the master regulator (8) and the slave regulators (10, 11, 12, 13) comprise an identical architecture and are arranged so as to establish multi-protocols communications.

3. System according to claim 1, characterized in that the master regulator (8) controls a flow of air blown in the place by means of a valve (27) and of a differential pressure probe (32) that are located on blowing duct (7).

4. System according to one of preceding claims, characterized in that the master regulator (8) manages the temperature and the air blown in the place according to the information transmitted by the plurality of slave regulators (10, 11, 12, 13).

5. System according to preceding claim, characterized in that the master regulator (8) includes at least one location wherein a communication daughter card (9) including a microprocessor and an interface, that are dedicated to a communication protocol of a given communication network, is inserted.

6. System according to the preceding claim, characterized in that the daughter card (9) is connected to another master regulator that manages a plurality of slave regulators arranged in another place.

7. System according to any of preceding claims, characterized in that the daughter card (9) is connected to an industrial network (39) linking a plurality of master regulators, said industrial network being managed by a supervisor (36).

8. System according to any of preceding claims, characterize in that the supervisor (36) manages the industrial network (39) by means of a computer provided with a software for supervising and configuring the whole regulators.

9. System according to any of preceding claims, characterized in that the master regulator (8) transmits setpoints for face velocity, that are generated by a supervisor (36), to the slave regulators (10, 11, 12, 13), said setpoints being function of a cycle with a predetermined duration.

10. A method for controlling the face velocity for a set of aeraulic extraction equipments (1, 2, 3, 4), in particular hoods for laboratories, implemented in a system according to any of preceding claims, comprising:
a slave-type regulation (10, 12, 13, 14) for controlling the face velocity of air aspirated by each of said aeraulic extraction equipments;
a master-type regulation (8) for controlling air blown in the laboratory,
characterized in that it further comprises a management of a set of protocols for communication with a plurality of industrial networks (39) for providing a remote control of the master regulation and of the slave regulation.

11. Device for controlling the face velocity of an aeraulic extraction equipment (1, 2, 3, 4), in particular a hood for a laboratory, within a place, said equipment comprising means (8, 10, 12, 13, 14) for regulating the face velocity, means (18, 19, 20, 21, 23, 24, 25, 26) for controlling the flow of extracted air, and means (14, 15, 16, 17) for measuring the face velocity, characterized in that the regulating means (8, 10, 12, 13, 14) comprise a regulator including at least a location wherein a plurality of daughter cards including a microprocessor and an interface that are dedicated to a communication protocol of a given communication network can be inserted.

12. Device according to the preceding claim, characterized in that the said equipment further comprises a differential pressure probe (28, 29, 30, 31, 32) for measuring the flow of extracted air.

13. Device according to one of claims 11 and 12, characterized in that the means for measuring the face velocity comprise a face velocity probe (14, 15, 16, 17) transmitting digital data.

14. Device according to an of claims 11 to 13, characterized in that the means for controlling the extracted airflow comprise a valve (23, 24, 25, 26) controlled by a pneumatic motor.

15. Device according to any of claims 11 to 14, characterized in that the regulator comprises means for connection to a plurality of other regulators.

16. Device according to any of claims 11 to 15, characterized in that the daughter card is connected to a remote equipment (37) for centralized technical management.

17. Device according to any of claims 11 to 16, characterized in that the daughter card (9) comprises an optical interface.

18. Device according to any of claims 11 to 17, characterized in that the daughter card (9) includes a twisted-pairs interface.

19. Device according to any of claims 11 to 18, characterized in that the daughter card (9) includes a coaxial-cables interface.

20. device according to any of claims 11 to 19, characterized in that the daughter card (9) includes a radiofrequency interface.
